(19) United States
(12) Patent Application Publication
(10) Pub. No.: US 2014/0305388 A1
(43) Pub. Date: Oct. 16, 2014

(54) Drive System

(71) Applicant: Liebherr Machines Bulle SA, Bulle (CH)

(72) Inventors: Benoît GAY, Villars-sur Glane (CH); Michael DEEKEN, La Tour-de-Treme (CH); Marcus QUASTHOFF, Epagny (CH); Bouzid SEBA, Broch (CH); Damien DUJON, La Tour-de-Treme (CH)

(73) Assignee: Liebherr Machines Bulle SA, Bulle (CH)

(21) Appl. No.: 14/250,728

(22) Filed: Apr. 11, 2014

(30) Foreign Application Priority Data
Apr. 12, 2013 (CH) 00772/13

(51) Int. Cl. F02B 61/06

(52) U.S. Cl. CPC F02B 61/06
USPC 123/2

(57) ABSTRACT

A drive system has an internal combustion machine that drives a hydraulic system and/or that includes a controller actuating the internal combustion machine such that, with transient load moment, the internal combustion machine operates at a constant set speed. The drive system includes a flywheel accumulator that is connected with the output shaft of the internal combustion machine via a step-up gear unit.

### CROSS REFERENCE TO RELATED APPLICATIONS

This application claims priority under 35 U.S.C. §119 to Application No. 00772/13, filed Apr. 12, 2013, in Switzerland, the entire disclosure of which is expressly incorporated herein by reference,

### BACKGROUND OF THE INVENTION

The present invention relates to a drive system with an internal combustion engine which drives a hydraulic system and/or which includes a controller which actuates the internal combustion engine such that with transient load moment the same operates at a constant set speed.

In drive systems for driving a hydraulic system, the internal combustion engine usually is operated at a constant set speed, while the control of an implement is effected by an actuation of the hydraulic system. This results in transient load moments for the internal combustion engine, which the engine provides by a corresponding increase of the torque.

For a high system efficiency of the drive system it is necessary that the internal combustion machine operates at an energetically favorable or efficient operating point. The energetically optimum speed, however, usually is lower than the minimum speed at which the required maximum performance can be covered. In addition, the internal combustion machine must be operated such that the required power dynamics, i.e. the height of the power increase and the time interval within which this increase can be effected, can be covered. The operating speed necessary for this purpose usually again is greater than the speed with which the required maximum performance might be covered and hence distinctly higher than the energetically optimum speed.

The consequence is that at high percentages of time the internal combustion machine must be operated with a lower efficiency, so that the dynamic reserve is sufficiently high at any time.

When the output speed is chosen too low, two effects that slow down the provision of a sufficiently high output power, i.e. the reaching of the desired performance, will be present. A time-delayed increase of the output torque occurs, so that the load moment frequently rises considerably faster than the available torque. This results in an undesired speed decrease. The increased output power of the internal combustion machine, therefore, must be applied proceeding from a speed that, again, is smaller than the starting speed, which in turn once more leads to a delay of the torque increase.

It is known to arrange a flywheel accumulator at the output shaft of the internal combustion machine having an energy content that leads to a partial compensation of the drop in speed.

When the operating speed is reduced to improve energetic efficiency, however, the energy content of the flywheel accumulator, which depends on the square of the speed, also is reduced. Therefore, as the operating speed lowers, the compensation of the drop in speed with transient load moments via the flywheel accumulator worsens.

### SUMMARY OF THE INVENTION

It is one object of the present invention to provide a drive system which, despite a low operating speed, provides high torque dynamics.

According to the invention, this object is achieved by a drive system with an internal combustion machine which drives a hydraulic system. Alternatively or in addition, the internal combustion machine can include a controller which actuates the internal combustion machine such that with transient load moment the machine operates at a constant set speed. Furthermore, the drive system according to the invention includes a flywheel accumulator. According to the invention, the flywheel accumulator is connected with the output shaft of the internal combustion machine via a step-up gear unit.

Due to the fast-running flywheel accumulator according to the invention, the above-described problems, which arise in conventional flywheel accumulators with regard to the lowering of the operating speed, are avoided. The operating speed can easily be lowered, and by a corresponding choice of the step-up ratio, a correspondingly high rotational energy nevertheless can be stored in the flywheel accumulator. As compared to an increase of the mass moment of inertia of a flywheel accumulator arranged in the drive train this also has the advantage that the same rotational energy can be achieved with considerably smaller installation space and lower weight.

The internal combustion machine of the drive system according to the invention preferably is an internal combustion engine, such as a diesel engine.

Preferably, the set speed of the internal combustion machine according to the invention lies between 1000 and 2000 revolutions per minute. In particular, the set speed can lie between 1300 and 1800 revolutions per minute. Preferably, the use of the fast-running flywheel accumulator according to the invention provides for a reduction of the set speed as compared to conventional drives by 100 to 500 revolutions per minute, preferably by 200 to 400 revolutions per minute. Particularly preferably, a reduction of a conventional set speed of 1800 revolutions per minute to a range between 1300 and 1600, and in particular to a range between 1400 and 1500 revolutions per minute, is possible.

Preferably, an internal combustion machine is used which has a maximum speed between 1800 and 2500 revolutions, preferably between 1800 and 2200 revolutions per minute, and particularly preferably between 1800 and 2000 revolutions per minute

In a preferred exemplary embodiment, the step-up ratio between the speed of the drive shaft and the speed of the flywheel accumulator according to the invention can lie between 5 and 15. Particularly preferably, the flywheel accumulator is operated with a step-up ratio between 6 and 12.

In one exemplary embodiment, the mass of the flywheel can lie between 5 and 50 kg, preferably between 10 and 30 kg.

Furthermore, the moment of inertia of the flywheel accumulator can lie between 0.05 and 0.5 kg*m², and preferably between 0.1 and 0.2 kg*m².

As already explained above, the flywheel accumulator should serve to prevent a drop of the actual speed during an increase of the load moment or to provide a sufficient torque dynamic reserve at low set speeds.

In a first design variant, the flywheel accumulator constantly is connected with the output shaft of the internal combustion machine. By firmly coupling the flywheel accumulator to the output shaft it is ensured that the energy content of the flywheel accumulator also is actually available when the load moment suddenly rises.

Alternatively, the flywheel accumulator can be connected with the output shaft of the internal combustion machine via a clutch which on closing has a reaction time of less than 100 ms. The clutch can be actuated such that when he load moment rises, it connects the flywheel accumulator with the output shaft. Due to the fast reaction time it is ensured that the energy content of the flywheel accumulator is available sufficiently fast. Preferably, the clutch has a reaction time of less than 50 ms, and more preferably of less than 20 ms.

Such a clutch allows a more flexible use of the flywheel accumulator, but also means an increased expenditure.

According to one embodiment of the present invention, the flywheel accumulator can be connected with the output shaft of the internal combustion machine via a transmission. The transmission can be a gear wheel transmission, such as a planetary transmission. A belt or chain drive with corresponding step-up ratio can also be used as the transmission.

The internal combustion machine can drive one or more hydraulic drives.

Furthermore, further drives can be present, such as e.g. a generator, a circulation pump, a fan, and/or a compressor.

At the drive train, there can also be provided an e-machine and/or a hydraulic pump, which supplies power to or withdraws power from the drive system, in order to supply the same to an energy accumulator or provide the same to other power consumers.

The drives can directly be coupled with the crankshaft of the internal combustion machine or be coupled with the same mechanically by a step-up gear unit. In particular, there can be provided an arbitrary transmission, a torque converter, a clutch, or a ring or chain output. A step-up gear unit can be utilized for a single or several driven components.

A certain number of the above-mentioned driven components and primary sides of existing step-up gear units can directly be arranged along the crankshaft of the internal combustion machine. Furthermore, cascadings of the step-up gear units to multistage step-up gear units are possible.

The drive system of the present invention furthermore can include a transfer gear, via which the internal combustion machine is connected with a plurality of loads.

The flywheel accumulator can be connected with the output shaft of the internal combustion machine at a point between internal combustion machine and transfer gear, or with an output of the transfer gear.

In a further embodiment, the flywheel accumulator can be integrated into the transfer gear of the internal combustion machine. In this way, installation space can be saved.

According to the invention, the hydraulic system furthermore can include a controller which actuates the power consumption and/or power output of the hydraulic system. In particular, the actuation of the hydraulic system can be effected by actuating a variable displacement pump and/or a variable displacement motor. Alternatively or in addition, the actuation of the hydraulic system also can be effected by actuating one or more valves.

The hydraulic system according to the invention in particular can be working and/or traction hydraulics.

The internal combustion machine preferably is operated at an operating speed n3, which together with the flywheel accumulator according to the invention is able to cover the required power dynamics, the height of the power increase and the time interval within which this increase must be effected. Since in the lower and middle speed range the power dynamics of an internal combustion machine rises with increasing starting speed, the operating speed n3 generally is greater than an operating speed n2, which represents the minimum speed at which the required maximum performance can be covered. When the available power of the internal combustion machine is utilized at least approximately during an application, this speed n2 is greater than an energetically optimum speed n1 at which the internal combustion machine operates in its energetically most favorable operating point.

Due to the fast-running flywheel accumulator provided according to the invention, the operating speed n3, which is used as set speed for actuating the internal combustion machine, nevertheless can be reduced as compared to known drive systems, since the flywheel accumulator provides a sufficiently high dynamic reserve or compensates the reduction of the dynamic reserve.

Advantageously, the set speed at least is constant over a usual operating cycle in which the load moment rises and falls again. The transient load moment therefore is not compensated by varying the set speed, but by adapting the torque of the internal combustion machine.

According to the invention, the controller of the drive system preferably is equipped such that the set speed is adjustable for adjusting the dynamic reserve. Therefore, when an operator wishes a higher dynamic reserve, the set speed can be increased (by reducing the energetic efficiency).

The actuation of the implement driven by the drive system preferably is effected not by a direct actuation of the internal combustion machine, but by an actuation of the downstream hydraulic system. In particular, control signals of an operator preferably are converted into control signals for actuating the hydraulic system. This can result in a corresponding increase of the load moment acting on the internal combustion engine, which at constant set speed increases the output torque, in order to be able to provide the desired output power.

Beside the drive system according to the invention, the present invention furthermore comprises a method for operating a drive system with an internal combustion machine and with a flywheel accumulator, which is connected with the output shaft of the internal combustion machine via a step-up gear unit. According to the invention, the internal combustion machine is actuated such that with transient load moments the same operates at a constant set speed. Alternatively or in addition, the internal combustion machine drives a hydraulic system.

Preferably, a method according to the invention is effected as has already been described above with regard to the drive system according to the invention. In a preferred embodiment, the method according to the invention serves for operating a drive system as it has been described above.

The present invention furthermore comprises a traveling implement and/or a vehicle with a drive system as it has been described above. The drive system for example can serve for driving traveling gear and/or for driving work equipment.

Particularly preferably, the drive system drives at least one hydraulic pump of a hydraulic system. Preferably, the hydraulic system serves for driving work equipment and/or for driving traveling gear of the traveling implement and/or vehicle.

Preferably, the work equipment and/or the traveling gear is actuated by an operator by actuating the hydraulic system. Preferably, the actuation of the drive system is effected such as it has already been described above.

Furthermore preferably, the drive system is constructed such as it has already been described above.

A preferred case of application is a traveling implement and/or vehicle with an undercarriage and an uppercarriage arranged on the undercarriage about a vertical axis of rotation. This can be an earth-moving machine and/or a material handling machine, such as a crane or excavator.

When a particularly fast-running flywheel accumulator is used, the precession which acts on the flywheel accumulator during a rotation of the uppercarriage must be taken into account. This can lead to undesired forces acting on the involved components.

In a preferred embodiment, the axis of the flywheel accumulator therefore is arranged parallel to the axis of rotation of the uppercarriage. A rotation of the uppercarriage therefore does not effect a rotation of the axis of the flywheel accumulator, so that no precession forces act.

Alternatively or in addition, it is also possible to provide two flywheel accumulators with opposite axes of rotation. The axes of rotation can be arranged parallel to each other, and the flywheel accumulators can rotate in opposite directions. As a result, the precession forces on the flywheel accumulators at least partly cancel each other out during a rotation of the uppercarriage. Preferably, the two axes of rotation are arranged with approximately the same distance from the axis of rotation of the uppercarriage.

The drive system of the present invention can also be used in stationary applications. Therefore, the present invention furthermore comprises a stationary work system with a drive system according to the invention.

In a possible embodiment of the present invention the drive system is used for driving a generator and/or a hydraulic supply system.

The present invention will now be explained in detail with reference to exemplary embodiments and drawings.

### BRIEF DESCRIPTION OF THE DRAWINGS

FIG. 1 shows exemplary embodiment of the drive system according to the invention with a fast-running flywheel accumulator, and

FIG. 2 shows an exemplary embodiment of a traveling implement according to the invention with a drive system according to the invention.

### DETAILED DESCRIPTION OF THE DRAWINGS

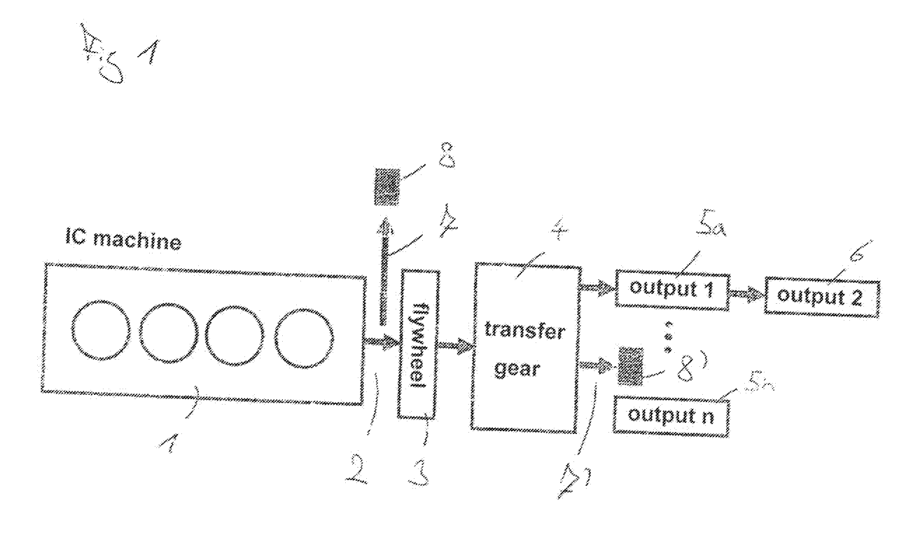

FIG. 1 shows an exemplary embodiment of a drive system according to the invention. There is provided an internal combustion machine 1, in the exemplary embodiment a diesel engine, which drives an arbitrary number of outputs 5a to 5n. In particular, one or more of the outputs 5a to 5n are hydraulic outputs. In particular, these can be hydraulic systems comprising at least one hydraulic pump and at least one hydraulic motor or hydraulic actuator, which are driven by the hydraulic pump.

In the exemplary embodiment, the hydraulic output 5a drives work equipment 6. In addition to the hydraulic outputs further outputs can be present, such as e.g. a generator, a circulation pump, a fan, and/or a compressor. At the drive train, an e-machine and/or a hydraulic pump also can be present, which can supply power to or withdraw power from the drive system, in order to supply the same to an energy accumulator or provide the same to other power consumers.

The above-mentioned outputs 5a to 5n can directly be coupled with the crankshaft 2 of the internal combustion machine. In the exemplary embodiment, however, a transfer gear 4 is provided, which mechanically couples the outputs 5a to 5n with the crankshaft 2 of the internal combustion machine. Each transfer gear 4 can provide step-up or step-down ratios for the individual outputs. Alternatively or in addition, one or more torque converters, clutches and/or belt or chain outputs can be provided for coupling the outputs to the crankshaft.

A step-up gear unit can be utilized for a single or also for several driven components. Furthermore, a certain number of driven components and primary sides of existing step-up gear units can directly be arranged along the crankshaft of the internal combustion machine. Furthermore, cascadings of the step-up gear units to multistage step-up gear units are possible.

In the exemplary embodiment, a conventional flywheel 3 furthermore is provided between the internal combustion machine 1 and the transfer gear 4, which rotates with the rotational speed of the crankshaft 2.

In the exemplary embodiment, the internal combustion machine is an internal combustion engine, in particular a diesel engine. In the exemplary embodiment, the internal combustion engine has a maximum working speed between 1800 and 2200 revolutions per minute. A usual operating speed for the internal combustion engine would be about 1800 revolutions.

It is an objective of the present invention to provide for a speed reduction from such an operating speed of 1800 to an operating speed between 1400 and 1500 revolutions per minute without loss of dynamics. In this way, a higher system efficiency of the drive system is achieved, since the internal combustion engine can operate at an energetically more favorable operating point.

The drive system includes a controller which holds the internal combustion machine 1 at a constant set speed during an application. The load moment of the outputs 5 on the other hand can be transient. If the hydraulics are working or traction hydraulics, the actuation of the implement or vehicle is effected by actuating the hydraulics, which accordingly requests alternating load moments from the internal combustion machine.

When the load moment increases, a certain period passes, until the internal combustion engine is able to generate the increased set torque and hence provide the desired performance. However, the increase of the load moment furthermore results in an unwanted drop in speed, which again increases the performance deficit between desired and actual performance. This will again increase the period, until the desired set torque is reached.

Due to the mass moments of inertia of the rotating drive train components, the drive system includes a rotational energy accumulator with an energy content that in turn leads to a partial compensation of the speed reduction. The rotational energy Eᵣₒₜ of a system mass moment of inertia θ and an angular speed ω amounts to:

Eᵣₒₜ=½ θ ω²

The decrease of the desired operational speed hence leads to a decrease in the energy content of the rotational energy accumulator. In the case of a transient desired output power of the internal combustion machine, the drop in speed with regard to the numerical value of the speed and also with regard to the time period which is required to again reach the set speed therefore is more pronounced as the operating speed gets lower.

In a conventional solution this effect might by counteracted by increasing the mass moment of inertia θ of the flywheel 3. However, such an increase of the flywheel 3 results in an increase of the installation space length and leads to a new flywheel housing being required.

According to the present invention, on the other hand, an additional flywheel 8 is provided, which is connected with the internal combustion machine via a step-up gear unit 7. Like the flywheel 8, the additional flywheel can be mounted on the motor side via a step-up gear unit 7 which is connected with the crankshaft 2. Alternatively, the additional flywheel also can be provided as flywheel 8′ as an additional output of the transfer gear 4. The step-up gear unit 7′ provided here hence can be integrated into the transfer gear 4. Furthermore, it is conceivable to completely integrate the additional flywheel into the transfer gear 4.

With a step-up ratio a speed of flywheel accumulator/speed of internal combustion machine, based on the crankshaft speed ω_{VKM} and in relation to a rotational energy Eᵣₒₜ of a flywheel accumulator without step-up gear unit, the rotational energy E_{rot,a} of the additional flywheel amounts to Eᵣₒₜ=½ θ a² ω_{VKM}²=a² Eᵣₒₜ.

By a corresponding adjustment of the step-up ratio, the rotational energy stored in the flywheel accumulator hence can be kept constant or even be increased despite a reduced operating speed ω_{VKM}.

A conceivable range for the used step-up ratios can lie between 5 and 15, preferably between 6 and 12. The mass of the flywheel for example can lie between 5 and 50 kg, preferably between 10 and 30 kg. The moment of inertia can lie between 0.05 and 0.5 kg*m², preferably between 0.1 and 0.2 kg*m².

Typical applications of the drive system according to the invention lie in the field of traveling implements in which the motor drives working and/or traction hydraulics. The control of the load is effected via an actuation of the hydraulics, in particular via an actuation of the hydraulic systems by actuating variable displacement pumps, variable displacement motors and/or valve arrangements. In such arrangements load jumps from 15% to 100% of the load usually occur within less than 150 ms.

The internal combustion machine is operated at a set speed which is constant over a typical load cycle. In particular, a corresponding speed control means therefore is provided.

To be able to utilize the rotational energy stored in the flywheel accumulator 8, 8′ according to the invention for at least partly compensating the load jumps, the same preferably is firmly coupled to the drive train. Possibly, however,a very quickly reacting clutch might also be used for connection of the flywheel accumulator, preferably a clutch with a reaction time of less than 10 ms.

The operating speed can be adjusted by the operator of the working machine in order to thereby specify the available dynamics. The flywheel accumulator according to the invention allows a reduction in the operating speed, in order to save fuel and nevertheless have sufficient dynamics.

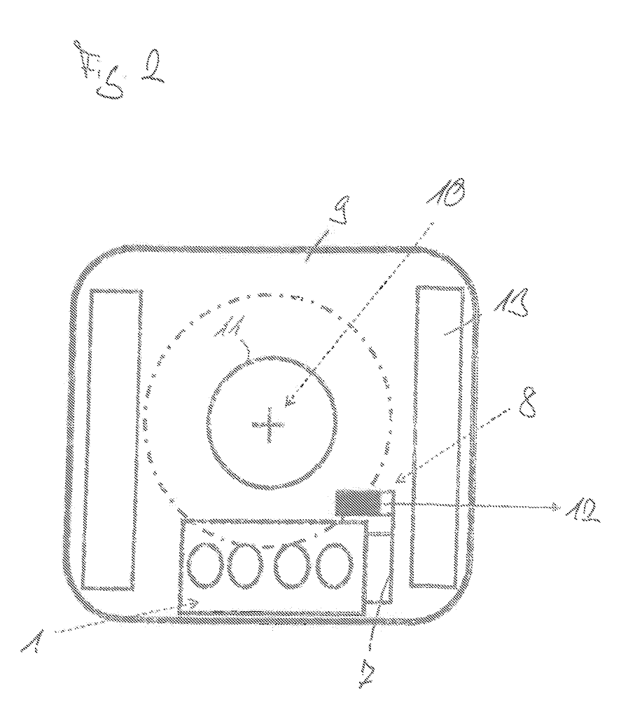

FIG. 2 shows a typical exemplary embodiment of a traveling implement according to the invention with a drive system according to the invention.

The traveling implement includes an undercarriage with a traveling gear 13, on which an uppercarriage 9 rotatable about a vertical axis of rotation 10 is arranged. A slewing ring 11 therefore is provided between undercarriage and uppercarriage. The traveling gear 13 can be one or more wheeled axles and/or a tracklaying gear.

On the uppercarriage, the internal combustion machine 1 is provided, which according to the invention drives a hydraulic system. The hydraulic system preferably at least drives the working hydraulics of the implement, for example one or more hydraulic cylinders and/or hydraulic motors for driving a work equipment, for example a boom, an arm and/or a winch. Furthermore, the working hydraulics also can be used for rotating the uppercarriage via a hydraulic motor. In addition, the hydraulic system also can serve for driving the traveling gear.

On the uppercarriage, there is also provided the fast-running flywheel accumulator 8 according to the invention, which is connected with the crankshaft of the internal combustion machine 1 via the step-up gear unit 7.

In the exemplary embodiment shown in FIG. 2, the axis of rotation 12 of the flywheel accumulator 8 lies in a plane which is vertical to the vertical axis of rotation 10 of the uppercarriage. Such arrangement allows a particularly easy connection to the crankshaft of the internal combustion machine, since the same also usually extends in this plane.

With such an arrangement, however, the precession acting due to the conservation of the angular momentum in the flywheel accumulator during rotation of the uppercarriage must be taken into account, which with excessive rotational energies in the flywheel accumulator can lead to undesired tilting movements of the uppercarriage. Furthermore, this leads to an increased load on the components, in particular on the pivot bearing 11.

In a typical operating cycle of an implement according to the invention, the uppercarriage is cyclically rotated in both directions about its vertical axis 10, in order to for example pick up bulk material via a grab or a shovel in a first rotary position and deposit the same again at another point.

This cyclic loading with fast load changes on the one hand requires a high dynamics of the drive system, which is provided by a correspondingly dimensioned flywheel accumulator 8 or step-up gear unit 7 according to the invention.

To avoid loading of the uppercarriage by precession forces, the axis of rotation 12 of the flywheel accumulator 8, other than shown in FIG. 2, can be arranged such that the precession forces are kept as low as possible. For example, the axis of rotation 12 of the flywheel accumulator can be arranged parallel to the axis of rotation 10 of the uppercarriage. Precession forces thereby can be avoided completely.

Furthermore, it is conceivable to distribute the energy storage to two identical rotation accumulators each with reverse angular momentum, for example to two rotation accumulators with parallel axes of rotation reversed with regard to the direction of rotation. With respect to the entire system, the precessions of the two flywheel accumulators thereby cancel each other out.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drive system comprising:
an internal combustion machine that drives a hydraulic system,
a controller that actuates the internal combustion machine such that, with transient load moment, the internal combustion machine operates a constant set speed,
a flywheel accumulator, and
a step-up gear unit by which the flywheel accumulator is connected an output shaft of the internal combustion machine.

2. The drive system according to claim 1, wherein the internal combustion machine is a diesel engine.

3. The drive system according to claim 1, wherein the set speed lies between 1000 and 2000 revolutions per minute.

4. The drive system according to claim 1, wherein a step-up ratio of the step-up gear unit lies between 5 and 15.

5. The drive system according to claim 1, wherein the flywheel accumulator has a flywheel with a mass that lies between 5 kg and 50 kg, or wherein the moment of inertia of the flywheel accumulator lies between 0.05 kg*m² and 0.5 kg*m².

6. The drive system according to claim 1, wherein the flywheel accumulator is constantly connected with the output shaft of the internal combustion machine.

7. The drive system according to claim 1, wherein the flywheel accumulator is connected with the output shaft of the internal combustion machine via a clutch which on closing has a reaction time of less than 100 ms.

8. The drive system according to claim 1, wherein the flywheel accumulator is connected with the output shaft of the internal combustion machine via a transmission.

9. The drive system according to claim 1, wherein the flywheel accumulator is integrated into a transfer gear of the internal combustion machine.

10. The drive system according to claim 1, further comprising a hydraulic system controller which actuates power consumption and/or output of the hydraulic system by actuating at least one of a variable displacement pump, a variable displacement motor, and a valve controller.

11. The drive system according to claim 1, wherein the hydraulic system is at least one of working and traction hydraulics.

12. The drive system according to claim 1, wherein the set speed is adjustable via a controller for adjusting a dynamic reserve.

13. The drive system according to claim 3, wherein the set speed lies between 1300 and 1800 revolutions per minute.

14. The drive system according to claim 4, wherein the step-up ratio lies between 6 and 12.

15. The drive system according to claim 5, wherein the mass lies between 10 kg and 30 kg.

16. The drive system according to claim 7, wherein the reaction time is less than 50 ms.

17. The drive system according to claim 7, wherein the reaction time is less than 20 ms.

18. A method for operating a drive system with an internal combustion machine and a flywheel accumulator connected with an output shaft of the internal combustion machine via a step-up gear unit, comprising actuating the internal combustion machine such that with transient load moments the internal combustion machine operates at a constant set speed, drives a hydraulic system, or both operates at the constant set speed and drives the hydraulic system.

19. A traveling implement and/or vehicle with a drive system according to claim 1, wherein the drive system serves for driving traveling gear, work equipment, or both traveling gear and work equipment, wherein the drive system drives at least one hydraulic pump of a hydraulic system, wherein the traveling implement and/or the vehicle comprises an undercarriage and an uppercarriage arranged on the undercarriage about a vertical axis of rotation, wherein the traveling implement is at least one of a crane and an excavator, and wherein the flywheel accumulator has an axis that is arranged parallel to an axis of rotation of the uppercarriage, two flywheel accumulators with opposite axes of rotation are provided, or two flywheel accumulators with opposite axes of rotation are provided, and at least one of the two flywheel accumulators has an axis that is arranged parallel to the axis of rotation of the undercarriage.

20. A stationary work system with a drive system according to claim 1, wherein the drive system advantageously is used for driving at least one of a generator and a hydraulic supply system.
